(19) United States
(12) Patent Application Publication
(10) Pub. No.: US 2026/0101173 A1
(43) Pub. Date: Apr. 9, 2026

(54) AUTO ESIM DELETION ON MOBILE DEVICES

(71) Applicant: T-MOBILE INNOVATIONS LLC, Overland Park, KS (US)

(72) Inventors: YingSheng LIANG, Auburn, WA (US); Anjani Deepthi NANDIGAM, Bothell, WA (US); Zoltan HOMORODI, North Bend, WA (US)

(21) Appl. No.: 18/910,593

(22) Filed: Oct. 9, 2024

(51) Int. Cl. H04W 8/18; H04L 67/55; H04W 4/12

(52) U.S. Cl. CPC H04W 8/183; H04L 67/55; H04W 4/12

(57) ABSTRACT

Systems and methods are provided for deletion of certain eSIMs in order to reduce waste and improve performance of a network and mobile devices, for example. In embodiments, it is determined an eSIM is not active or used, and/or cannot be authenticated. Based on such determinations, the eSIM can be remotely deleted from the mobile device, for example by causing a push notification to be received at the mobile device. In some cases, an eSIM is deleted from a phone or tablet, or from a vehicle or other device. The user or operator of the mobile device is not required to interact with the notification in order for it to direct the deletion of an eSIM, in embodiments.

### SUMMARY

A high-level overview of various aspects of the invention are provided here, to provide an overview of the disclosure and to introduce a selection of concepts that are further described in the detailed-description section below. This summary is not intended to identify key features or essential features of the claimed subject matter, nor is it intended to be used as an aid in isolation to determine the scope of the claimed subject matter. The present disclosure is directed, in part, to systems and methods for deletion of non-active embedded SIMs (“eSIMs”) in order to reduce waste and improve performance of a network and mobile devices.

In aspects set forth herein, and at a high level, the systems and methods comprise solutions directed to identifying mobile devices (for example devices that have not connected to a network for a period of time) and determining if the mobile devices are associated with non-active eSIMs, for example, and providing notifications to the devices in some circumstances to cause deletion of the non-active eSIMs, in embodiments. The systems and methods include solutions for ensuring active eSIMs are not deleted, even if the network is not able to authenticate specific eSIMs, as discussed in more detail below. This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Devices used for communication, such as mobile phones and tablets, have used technology referred to as Subscriber Identity Module (“SIM”) cards. SIM cards are used to associate a mobile device with an account or plan, for example, so that calls and data can be routed to the mobile device. SIM cards can also be used to track service provided to a mobile device. In general, SIM cards have been needed to enable mobile devices to connect to services including phone and Internet services, for example. A phone or tablet may be able to connect to 5G services and/or send SMS messages, for instance, using a SIM card. Traditional SIM cards are physical cards or components included with a device, for example. In some cases, SIM cards can be removed from a mobile device or are manufactured separately and affixed to a mobile device.

Over time, mobile devices began using a type of SIM called an eSIM instead of physical SIM cards. An eSIM can be a virtual SIM card or a software-based SIM card, for example, associated with specific hardware aspects of a mobile device. Some mobile devices, such as phones, are manufactured by original equipment manufacturers (“OEMs”) without a physical SIM card and/or not configured to be used with a physically-removable SIM card, such as a SIM card that must be removed or replaced in order to associate a mobile device with a new account, for example, but the manufacturers or other entities include hardware configured to support an eSIM. In some cases, a SIM is a multi-IMSI (allowing multiple International Mobile Subscriber Identities), for example.

An embedded SIM may be digital but still associated with specific hardware aspects of a mobile device, such as a portion of circuitry designated by a manufacturer. A hardware aspect can be in communication with a control or command aspect of a mobile device, which can be used to instruct the deletion of a specific digital SIM (based on a command or signal from a push notification), as discussed below. An eSIM can also refer to a SIM that is embedded, for example it may not be removable or independent from one or more other components of a mobile device.

An eSIM allows a mobile device such as user equipment (“UE”) (e.g., UE 104 in FIG. 1) to connect to a network, for example. An eSIM is required in many types of mobile devices including 5G devices, in some cases. The eSIM can holds user or customer identification information (e.g., an ID number) and details regarding how the devices can connect to a network. An eSIM can allow a mobile device to use a data or text plan, or roam, for instance. Various devices can use eSIM functionality, such as mobile phones, tablets, watches, vehicles, or other mobile vehicles or devices. In some cases, eSIM functionality may use particular structure(s) or hardware included in a device although the eSIM may be comprised of software.

Using an eSIM card instead of (or in addition to) a SIM card can provide advantages to mobile device users and network operators. As one example, an embedded and/or non-removable eSIM card can be less susceptible to unauthorized access or tampering. As another example, a virtual SIM card may be more convenient because it permits remote activation or switching of service plans for a mobile device. Mobile devices such as a phone and remote-controlled devices that use eSIMs may be able to use more than one profile or phone number, or eSIM card, per device.

Another advantage of eSIMs should be that an eSIM can be re-used once a subscription or plan associated with a mobile device has ended for a subscriber, without requiring a subscriber to return a physical SIM card. For instance, a user of a device can cancel a service plan (e.g., for data and/or voice service) or perform a “swap” to associate another SIM with the device. In cases like this, the old or prior eSIM should be available for re-use by a carrier or network provider. However, certain issues arise in the context of out-of-date or unused eSIMs associated with devices.

As one example, after eSIMs are cancelled or swapped, an old eSIM needs to be deleted but is often not deleted, leading to specific challenges in the context of virtual SIMs used with mobile devices. Traditional or physically-removable SIM cards would be removed by users because they needed to make space for a new SIM card, in some cases, but this is not necessary with eSIMs, therefore many eSIMs are not deleted.

The eSIMs that are not deleted become wasted and can cause significant costs to carriers or other network providers. A substantial amount of eSIMs, in some cases even a majority of eSIMs, are not being removed or deleted and thus are not eligible to be reused. An eSIM that cannot be reused will require unnecessary resources, for example storage space and management that may incur substantial time and cost resources to serve by a carrier or network operator. Each eSIM that is no longer active or in use, but is still associated with a mobile device, can require significant resources on a recurring basis.

If an entity such as a network or service provider attempts to reuse an eSIM without fully deleting or removing the eSIM from a prior device, this can present security or privacy concerns. A provider may not be able to comply with data, user, or device standards if it attempts to reuse eSIMs or devices without confirming deletion of eSIM data, or without treating the eSIM data according to its policies. Additionally, operating or using mobile devices with an outdated eSIM that has not been deleted, alongside another SIM or other identifier, can cause security or fraud risks, such as a risk that an unauthorized user may obtain or access eSIM data that should have been removed.

Therefore, the failure to delete an eSIM from a mobile device causes the unnecessary use of resources by a provider, because the eSIM cannot be reused, and by a device associated with the eSIM, in some cases. For example, a device may demonstrate a reduced performance and/or a waste of hardware components within the device due to an eSIM that is not needed or used. An entity may be forced to devote processing and/or storage resources to an old or outdated eSIM, but an entity may be unable to communicate with a device.

Other issues arise, as well, in the context of eSIMs. As another example, if eSIMs are not removed from devices when they are no longer in use (for example if a plan or agreement has expired), then a provider of eSIMs does not have full control over each eSIM in its system or issued by the provider. Further, a network provider does not have an ability to automatically monitor for, or identify, eSIMs for potential deletion by a computerized system for reducing resources dedicated to eSIMs. In the context of eSIMs, network providers do not have a system or method for a communication flow with devices to delete eSIMs as disclosed herein. As another example, in the context of eSIMs, current systems and methods fail to cause deletion of eSIMs and fail to ensure against disruption of service(s) for devices where an eSIM should be maintained, which can present a safety risk to users of mobile devices.

As described herein, embodiments of the present invention provide solutions to issues arising in the context of virtual or software-based SIM cards. At a high level, embodiments are able to validate that an eSIM is not associated with an active subscription. In some cases, based on this validation, a system instructs a device to delete an eSIM from the device, without requiring any direct or specific physical interactions with the device. This can avoid substantial waste by network components and/or the device.

The solutions described herein make mobile devices more secure, by removing eSIMs that are not active and archiving or securing eSIM data for reference and reuse. Additionally, network components and storage have more available resources when non-active eSIMs are removed from devices and systems. Embodiments of the invention also provide improvements to remote communication options with devices to enable remote action relating to an eSIM, and provide automatic systems for determining and eliminating eSIMs. As described below, the solutions provide safeguards to avoid unwanted removals of eSIMs, in some cases, to offer improved use of resources without risk to active eSIMs. Embodiments include specific technologies for pushing action items to a mobile device that is not in use or not connected to a network.

An eSIM may be integrated into hardware in a mobile device. In some cases, the structure(s) can be specific circuitry, or in communication with such circuitry, such that an eSIM or its associated components can be designed to receive information from messages including push notifications. In embodiments, a device is configured to receive or handle a push notification outside of an application, for example using a radio or WiFi network, that commands the device to erase or terminate an eSIM that is associated with the device. In some cases, embodiments are able to validate an old eSIM to determine no active subscription or other outstanding issue is linked to the eSIM, then inform the device to delete the eSIM, without any requirement for an end user to operate the device itself or approve the deletion.

As discussed in more detail below, exemplary use cases include, in one example, an eSIM that is out-of-date yet still communicates with a network or may attempt to communicate with a network. For instance, a customer may be a subscriber of a carrier. The customer can call customer service for the carrier to cancel their subscription or service plan, or to perform a “sim swap,” rendering the customer's eSIM out-of-date. The customer is not required to remove this old eSIM in order to proceed with a new service plan, for example (compared to non-eSIM cards). At this point, in general, a carrier will update its billing system to cancel the customer's subscription or service, or the carrier will change the customer's subscription to another eSIM or SIM card in the same customer device or another device. The old eSIM may still be enabled in the device and may still attempt to connect to a network. In this example, embodiments of the present invention are configured to notify the device the eSIM has no active subscriptions and/or instruct the device to delete the eSIM.

In another example, an old eSIM no longer connects to a network or it no longer attempts to connect to a network, but it has not been deleted from a device. The eSIM may be considered cancelled or “swapped out” by network component(s), but the eSIM can still be stored in memory of a device and managed or tracked by a network, consuming unnecessary resources. Embodiments of the present invention can provide notifications to the device to cause a remote deletion of the eSIM so that the eSIM can be reused by another device. In some cases, the computerized systems described herein automatically determine eSIMs to be deleted from devices and cause such deletions, freeing resources in a network and available to the devices.

### BRIEF DESCRIPTION OF THE SEVERAL VIEWS OF THE DRAWINGS

Implementations of the present disclosure are described in detail below with reference to the attached drawing figures, wherein:

FIG. 1 depicts an exemplary environment suitable for use in implementations of the present disclosure, in accordance with aspects herein;

FIG. 2 depicts an exemplary diagram including representations of communications suitable for use in implementations of the present disclosure, in accordance with aspects herein;

FIG. 3 depicts an exemplary diagram including representations of communications suitable for use in implementations of the present disclosure, in accordance with aspects herein;

FIG. 4 depicts an exemplary interface suitable for use in implementations of the present disclosure, in accordance with aspects herein;

FIG. 5 depicts an exemplary computing environment suitable for use in implementations of the present disclosure, in accordance with aspects herein;

FIG. 6 depicts an exemplary flow diagram in accordance with embodiments described herein; and

FIG. 7 depicts an exemplary flow diagram in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
API Application Programming Interface
CD-ROM Compact Disk Read Only Memory
CDMA Code Division Multiple Access
eNB Evolved Node B
gNB Next Generation Node B
GPRS General Packet Radio Service
GSM Global System for Mobile communications
DVD Digital Versatile Discs
EEPROM Electrically Erasable Programmable Read Only Memory
EMS Enhanced Message Service
FD-MIMO Full-Dimension Multiple-Input Multiple-Output
IMS IP Multimedia Subsystem
IMSI International Mobile Subscriber Identifier
IoT Internet-of-Things
LMF Location Management Function
LTE Long Term Evolution
MIMO Multiple-Input Multiple-Output
MMS Multi-media Message Service
MU-MIMO Multi-User Multiple-Input Multiple-Output
PC Personal Computer
PDA Personal Digital Assistant
RAM Random Access Memory
RF Radio-Frequency
RFID Radio Frequency Identification
ROM Read Only Memory
RRU Remote Radio Unit
SIM Subscriber Identity Module
TDMA Time Division Multiple Access

In addition, words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

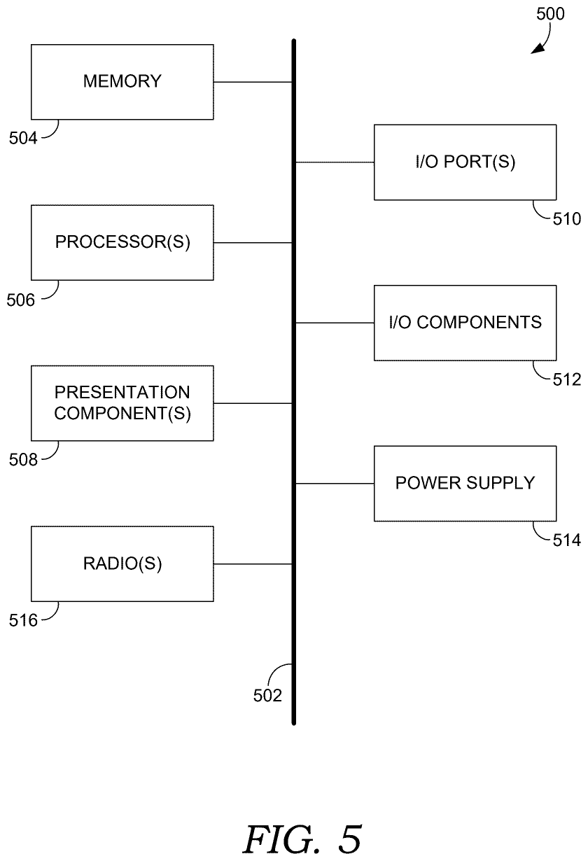

Additionally, a “user device,” as used herein, is a device that has the capability of using a wireless communications network, and may also be referred to as a “computing device,” “mobile device,” “wireless communication device,” or “user equipment” (“UE”). A user device, in some aspects, may take on a variety of forms, such as a PC, a laptop computer, a tablet, a mobile phone, a PDA, a server, or any other device that is capable of communicating with other devices (e.g., by transmitting or receiving a signal) using a wireless communication. A UE may be, in an embodiment, computing device 500, described herein with respect to FIG. 5, below.

A computing device may additionally include Internet-of-Things (IoT) devices, such as one or more of the following: a sensor, controller (e.g., a lighting controller, a thermostat), appliances (e.g., a smart refrigerator, a smart air conditioner, a smart alarm system), other Internet-of-Things devices, or combinations thereof. Internet-of-Things devices may be stationary, mobile, or both. In some aspects, a computing device is associated with a vehicle (e.g., a video system in a car capable of receiving media content stored by a media device in a house when coupled to the media device via a local area network). In some aspects, a computing device comprises a medical device, a location monitor, a clock, other wireless communication devices, or combinations thereof.

Further, the term “telecommunications network service” provided by the IMS layer, as used herein, includes wireless communications via the transfer of information via one or more of the following: radio waves (e.g., Bluetooth®), satellite communication, infrared communication, microwave communication, Wi-Fi, and mobile communication. Telecommunications network services may be provided via one or more wireless telecommunication technologies or standards, including, but not limited to, CDMA 1×Advanced, GPRS, Ev-DO, TDMA, GSM, WiMax technology, LTE, LTE Advanced, 4G, 5G, 6G, or other generation communication systems, among other technologies and standards. The telecommunications network services may be provided via a network (e.g., the transfer of information without the use of an electrical conductor as the transferring medium).

In aspects, the network may be a telecommunications network(s), or a portion thereof. A telecommunications network might include an array of devices or components (e.g., one or more cell sites). The network can include multiple networks, and the network can be a network of networks. In embodiments, the network is a core network, such as an evolved packet core, which may include at least one mobility management entity, at least one serving gateway, and at least one Packet Data Network gateway. The mobility management entity may manage non-access stratum (e.g., control plane) functions such as mobility, authentication, and bearer management for other devices associated with the evolved packet core.

In some aspects, a telecommunications network can connect one or more subscribers to a corresponding immediate service provider for services such as 5G and LTE, for example. In aspects, a network provides voice, message (e.g., SMS messages, MMS messages, instant messaging messages, EMS messages), or data services to user devices or corresponding users that are registered or subscribed to utilize the services provided by a telecommunications provider. The network can comprise any communication network providing voice, message, or data service(s), such as, for example, a 1× circuit voice, a 3G network (e.g., CDMA, CDMA2000, WCDMA, GSM, UMTS), a 4G network (WiMAX, LTE, HSDPA), a 5G network, a 6G network, and any combination thereof.

Components of the network, such as terminals, links, and nodes (as well as other components), can provide connectivity in various implementations. For example, components of the network may include core network nodes, relay devices, integrated access and backhaul nodes, macro eNBs, small cell eNBs, gNBs, relay cell sites, LMFs, or other network components. The network may interface with cell sites or access points through one or more wired or wireless backhauls. As such, the cell site and access point may communicate via the network or directly. Furthermore, user devices can utilize the network to communicate with other devices (e.g., a mobile device(s), a server(s), a personal computer(s), etc.) through the cell site or access point.

As used herein, the term “cell site” (used for providing UEs with access to the telecommunications network services) generally refers to one or more cellular base stations, nodes, RRUs control components, and the like (configured to provide a wireless interface between a wired network and a wirelessly connected user device). A cell site may comprise one or more nodes (e.g., eNB, gNB, and the like) that are configured to communicate with user devices. In some aspects, the cell site may include one or more band pass filters, radios, antenna arrays, power amplifiers, transmitters/receivers, digital signal processors, control electronics, GPS equipment, and the like. An eNB or gNB corresponding to the cell site may comprise one or more of a macro base station, a small cell or femto base station, a relay, and so forth. In aspects, the cell site may be configured as FD-MIMO, massive MIMO, MU-MIMO, cooperative MIMO, 3G, 4G, 5G, another generation communication system, or 802.11. In addition, the cell site may operate in an extremely high frequency region of the spectrum (e.g., from 30 GHz to 300 GHz), also known as the millimeter band.

Embodiments of the technology described herein may be embodied as, among other things, a method, system, or computer-program product. Accordingly, the embodiments may take the form of a hardware embodiment, or an embodiment combining software and hardware. An embodiment that takes the form of a computer-program product can include computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

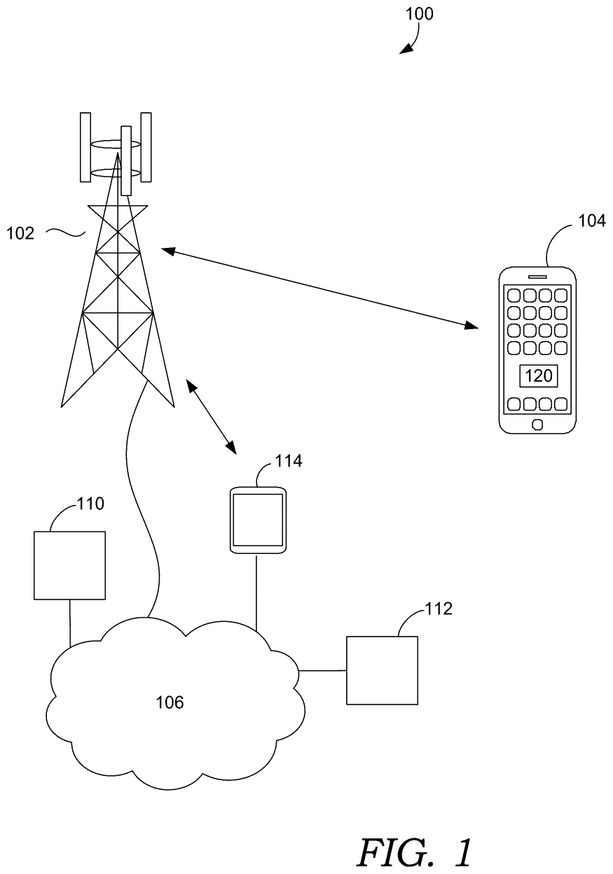

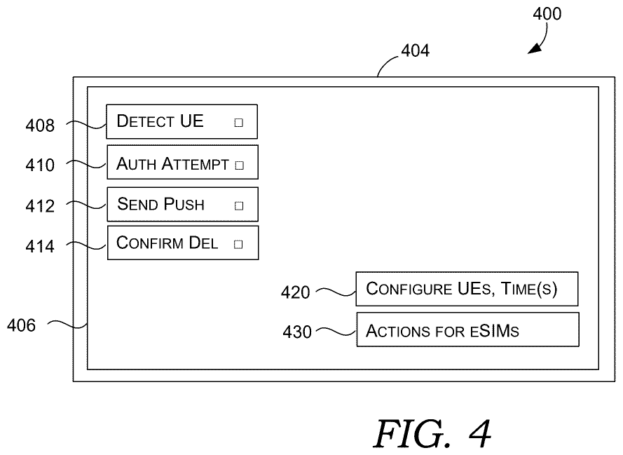

Turning to FIG. 1, an exemplary environment 100 is illustrated in accordance with embodiments described herein. As shown, a base station 102 can provide a signal, for example, and communications to and from UE 104. A network 106 can be provided by a carrier or other network provider, including, in some cases, a backend 110 and an entitlement component 112. Backend 110 and entitlement component 112 can be accessed via network 106 or separately accessed by a carrier entity, and they can be controlled by a carrier or network provider. In some cases, backend 110 represents one or more backend servers that are used or controlled by a network provider and entitlement component 112 represents server(s) or systems comprising a carrier entitlement system, which can provide responses to requests from other network components regarding subscriptions and eSIMs. Continuing with FIG. 1, a network device 114 is shown, which may connect to network 106 or communicate with base station 102, in some cases to configure or cause embodiments of the present invention to identify and delete an eSIM (e.g., eSIM 120) from UE 104, as discussed in more detail below with respect to FIGS. 4A and 4B.

An entitlement component 112 can be comprised of one or more servers or proxies, which can communicate with Application Programming Interfaces (“APIs”) to handle authentication, for example. A backend 110 can comprise one or more components related to billing, for example to determine if an identification or other subscription or service information is active according to billing or other backend 110 records. In some cases, backend 110 comprises various components including stored information, or backend 110 includes distributed aspects and/or is configured to access stored indicators of whether an eSIM or account or other criteria appears to be active or not. In some cases, backend 110 can determine an active billing status or not, or another criteria, such as a hold on a deletion for other technical or service- or compliance-related reasons.

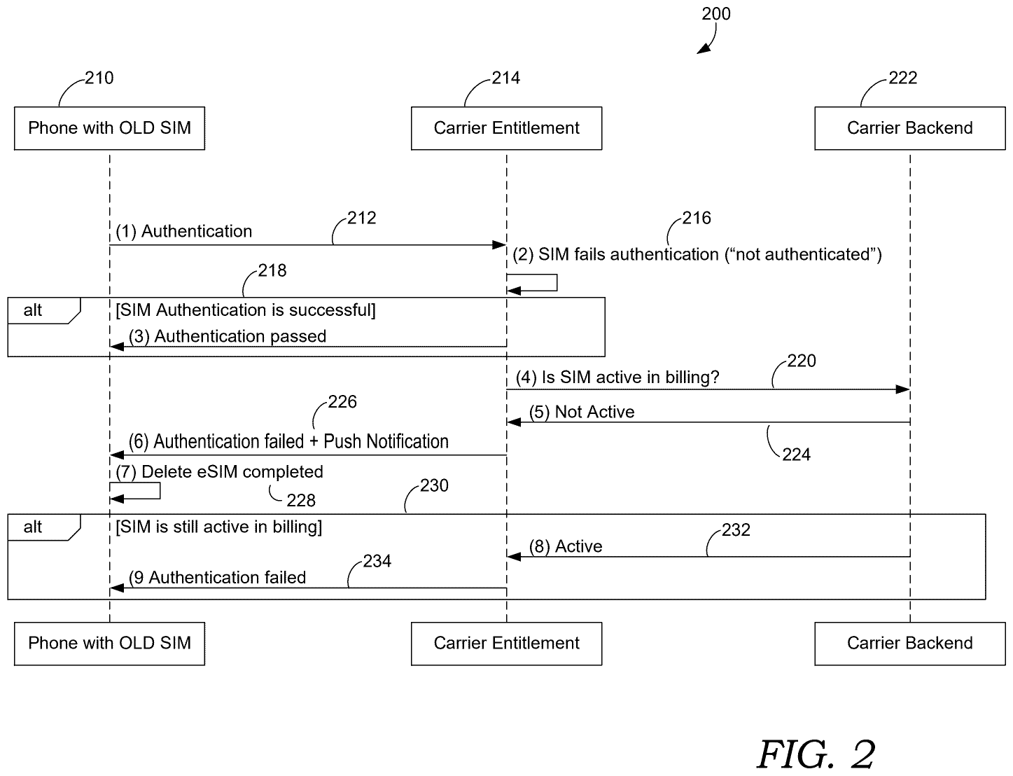

FIG. 2 is an exemplary flow diagram 200 in accordance with embodiments described herein. In this scenario, an out-of-date or old SIM (e.g., an eSIM that no longer being used by a mobile device or a user of the mobile device) is still communicating with or attempting to communicate with a carrier network, such as network 106 in FIG. 1. Continuing with FIG. 2, a UE 210 is shown at left, for example a mobile phone associated with an old SIM. An authentication attempt 212 occurs between UE 210 and carrier entitlement 214 (e.g., a carrier entity or server(s), which may correspond to entitlement component 112 in FIG. 1). At non-authentication response 216, it may be indicated by carrier entitlement 214 that a SIM is not authenticated. In this example, a SIM may correspond to eSIM 120 as shown in FIG. 1.

Continuing with FIG. 2, as an alternative to non-authentication response 216, carrier entitlement 214 can provide an authentication response 218 indicating a SIM authentication is successful. In this alternative scenario, the system can reach an endpoint with respect to UE 210 when SIM authentication is successful, as shown at response 218. In this example, because the SIM has passed authentication, the system can terminate the attempt to identify UE 210 for eSIM deletion.

In the example illustrated in FIG. 2, if the SIM fails authentication as shown at non-authentication response 216, the system continues with request 220, which inquires from carrier backend 222 whether the SIM is active, for example according to billing records or other indications. In some cases, request 220 can seek other information from a carrier backend 222 that may impact whether a system will cause the deletion of a SIM. For instance, systems and methods disclosed herein may automatically cause deletion of an eSIM from UE 210 unless a request 220 indicates an active SIM or other hold or outstanding issue that prevents the deletion of the eSIM.

Continuing with the example in FIG. 2, a response 224 indicates a SIM is not active according to an entity, such as a carrier. In this case, a message 226 is transmitted to UE 210, in embodiments. Message 226 can be sent from a carrier or activated by a carrier, for example one or more servers comprising a carrier entitlement 214 or other network components. As described herein, an OEM or other entity configures UE 210 to receive message 226 after it is triggered. UE 210 does not require an active application or other specific program in order to receive message 226.

Message 226 can be received by hardware or software regardless of any particular program or application being open or running on a device, such as UE 210. Message 226 can be received or acknowledged by software at a mobile device (e.g., UE 210 in FIG. 2). The software can be installed or built-in to mobile devices by a manufacturer, such as an OEM of mobile phones. In some embodiments, an OEM has made an adjustment to software associated with a mobile device to acknowledge a push notification sent outside of an application, which can be received by a mobile device and acted on to delete an eSIM without requiring any user of the mobile device to open or accept any messages or instructions.

In some cases, message 226 is received without using an application layer, for example by communicating using one or more layers below the application layer (e.g., a physical, data link, and/or network layer). Message 226 is a push notification received over a wireless network, such as network 106 in FIG. 1, or using another signal such as Bluetooth or WiFi, in embodiments. In one example, message 226 is an encrypted push notification that is decrypted by software on a UE 210. Message 226 is able to activate a menu and/or a menu selection, or an application on a mobile device (e.g., UE 210), without user intervention, in some embodiments. A message 226 can be a push notification that is received by UE 210 and automatically causes a menu to be accessed and deletion of an eSIM to be automatically selected and/or confirmed. In some examples, a network provider such as a carrier requests an OEM to send message 226, or, in other cases, an OEM configures a mobile device to receive message 226 provided by a carrier.

Message 226 is a push notification in association with a failed authentication, in embodiments, which activates the deletion of a SIM from UE 210 (e.g., eSIM 120 as shown in FIG. 1 with respect to UE 104). As shown at deletion 228, the removal of an eSIM from UE 210 is completed in response to message 226. Deletion 228 can comprise a confirmation of the swiping of eSIM data from UE 210 so that a carrier or network 106 can determine the eSIM is available for reuse. In some cases, deletion 228 provides a notification to network 106 that an eSIM can be deleted from storage and/or disassociated with UE 210.

As an alternative scenario 230, a carrier returns an indication 232 that a SIM is active, for example due to billing records or other parameters showing use or obligations to a customer. In this example, when the indication 232 shows the SIM is still active, the system does not send a push notification or other message to cause deletion of the SIM. As shown at response 234, a carrier can still indicate that authentication of the SIM failed. In some cases, this can cause UE 210 to be analyzed by the system again after a predetermined amount of time to determine if the SIM is still active.

In another example, the alternative scenario 230 can relate to an eSIM that is recently-activated or new in billing system or records. In this case, it may take time for the core network to recognize or authenticate the eSIM. During this period, authentication may fail (e.g., as shown at response 234), but because the eSIM is active or in use according to a provider, it is still not commanded to be deleted even though the authentication failed. Although the system receives a response 234 of authentication failing, for example, it still does not trigger a push notification that would cause deletion at UE 210.

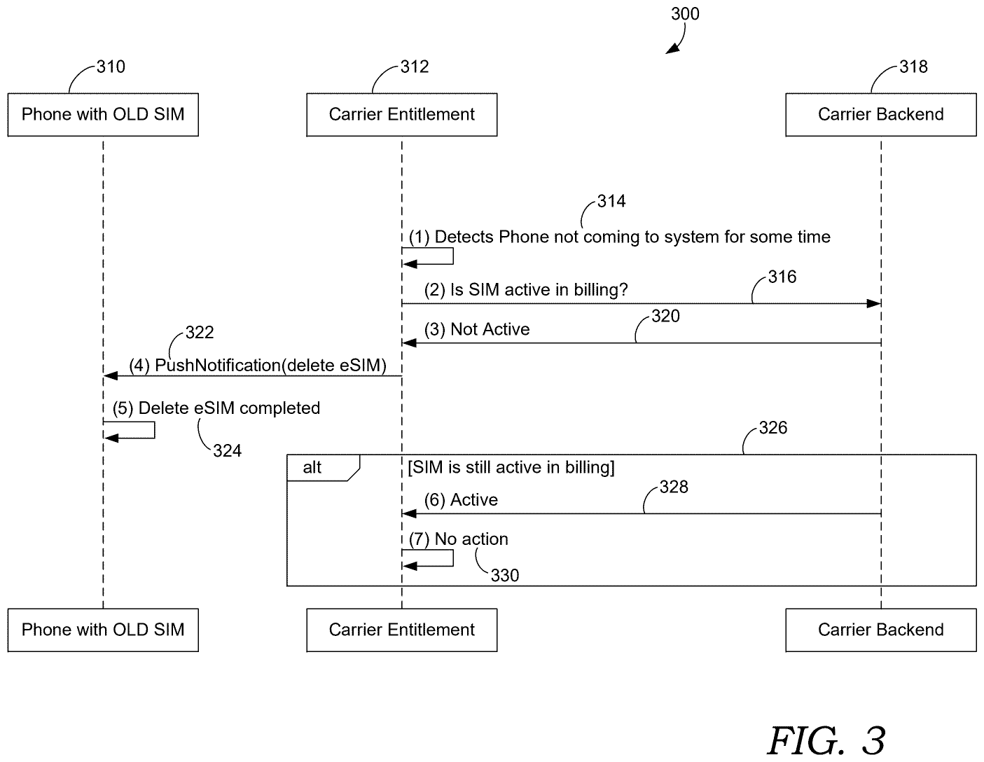

Turning now to FIG. 3, an exemplary flow diagram 300 is shown in accordance with embodiments. In this example, a UE 310 is associated with an old or unused SIM. A carrier front-end entity 312 (for example, a carrier entitlement entity) makes a determination 314 that a particular device, such as a mobile phone, has not communicated with the system for a predetermined amount of time. In some cases, this determination can be configured to be automatically made by the system based on a period of time during which a mobile device has not connected to any components of a network, such as network 106 in FIG. 1. This period of time can be set as an amount of days or weeks. The determination can also be made, in part, based on other factors such as actions related to billing or account status, location information, expiration of a plan, or indications that a particular mobile device has implemented a different or alternative eSIM, indicating a prior eSIM is out-of-date or unused.

Based on the determination 314, carrier entity 312 sends a request 316, in embodiments, issued to a backend 318, such as a network or server component. Request 316 is directed to whether a SIM is active or in use according to a service provider, for example. Backend 318 provides response 320, in this case, which indicates the SIM at issue is not in use. Based on response 320, a carrier entity 312 can cause notification 322 to be sent to UE 310. Notification 322 is a push notification that causes UE 310 to delete an eSIM. As shown at deletion 324, UE 310 acts based on notification 322 to remove an eSIM from UE 310, in embodiments. Deletion 324 can include a confirmation provided to a component of network 106 to indicate the eSIM has been removed and is available for reuse by another mobile device.

Continuing with FIG. 3, an alternative scenario 326 is illustrated where the SIM is still indicated as active, or in use, according to a network provider, for example according to backend 318, which provides response 328. Based on response 328 indicating an active SIM, no action is taken by a carrier at step 330. For example, in this exemplary embodiment, no push notification is sent to UE 310 because the system is not configured to cause deletion of active SIMs.

FIG. 4 shows an exemplary interface 400 displayed on a user device 404. In an embodiment, user device 404 can be provided, for example by a carrier, to aid in implementing or monitoring systems and methods described herein. For example, in some cases, a system automatically determines UEs that are candidates for potential SIM removal and proceeds with actions illustrated in FIG. 2 or 3. In some circumstances, a user may desire to cause certain actions from a portal 406 using controls 408, 410, 412, 414. FIG. 4 shows one example of a portal 406 that may be provided on a device or component in network 106 for implementing embodiments. In some cases, a portal 406 is used to configure a system for identifying UEs, as shown at 420. For example, a carrier or other entity can flag UEs by selecting or inputting them into portal 406, which will cause the system to automatically perform determinations and deletions as described herein. In other cases, the time frames for determining a UE has not contacted a network 106 and/or the time frames for expecting a UE to be active but not able to be authenticated can be configured so they can be implemented automatically. Portal 406 can also allow for setting actions to be taken for eSIMs, for example archiving each eSIM after deletion or otherwise making a record so that the system is aware an eSIM is available for reuse. The options displayed on exemplary portal 406 can be expanded or selected to view fuller menus with specific options for identifying UEs and/or transferring eSIMs, for example.

If a system automatically determines to send one or more push notifications to UEs as described herein, a carrier or other entity can use a carrier-level message capability generated by manufacturers of mobile devices, for example a messaging protocol enabled in association with hardware or software used for eSIM(s) in each mobile device. In some cases, an OEM or carrier triggers a program or executable code on a mobile device (or provides such code to be used when triggered) to delete an eSIM. This code can be stored or inserted alongside a user profile or other information on a UE, such as UE 104 in FIG. 1.

In some cases, a push notification (e.g., message 226 in FIG. 2 or notification 322 in FIG. 3) is triggered by a carrier or another entity but not immediately delivered to a UE, such as UE 210 in FIG. 2. The push notification can be stored or queued for when power is restored or a connection is enabled, in some cases where the push notification includes expiration or renewal settings. In certain cases, the push notification itself can include connection instructions for interacting with a UE as enabled by a mobile-device manufacturer for purposes of receiving an eSIM-deletion notification. A push notification can be encrypted until received and/or decrypted by a UE, such as UE 210.

In FIG. 5, a diagram is depicted of an exemplary computing environment suitable for use in implementations of the present disclosure. In particular, the exemplary computer environment is shown and designated generally as computing device 500. Computing device 500 is but one example of a suitable computing environment and is not intended to suggest any limitation as to the scope of use or functionality of the invention. Neither should computing device 500 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 5, computing device 500 includes bus 502 that directly or indirectly couples the following devices: memory 504, one or more processors 506, one or more presentation components 508, input/output (I/O) ports 510, I/O components 512, power supply 514 and radio(s) 516. Bus 502 represents what may be one or more busses (such as an address bus, data bus, or combination thereof). Although the devices of FIG. 5 are shown with lines for the sake of clarity, in reality, delineating various components is not so clear, and metaphorically, the lines would more accurately be grey and fuzzy. For example, one may consider a presentation component, such as a display device to be one of I/O components 512. Also, processors, such as one or more processors 506, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 5 and refer to “computer” or “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media includes RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

Memory 504 includes computer-storage media in the form of volatile and/or nonvolatile memory. Memory 504 may be removable, non-removable, or a combination thereof. Exemplary memory includes solid-state memory, hard drives, optical-disc drives, etc. Computing device 500 includes one or more processors 506 that read data from various entities, such as bus 502, memory 504, or I/O components 512. One or more presentation components 508 presents data indications to a person or other device. Exemplary one or more presentation components 508 include a display device, speaker, printing component, vibrating component, etc. I/O ports 510 allow computing device 500 to be logically coupled to other devices, including I/O components 512, some of which may be built in computing device 500. Illustrative I/O components 512 include a microphone, joystick, game pad, satellite dish, scanner, printer, wireless device, etc.

Radio 516 represents a radio that facilitates communication with a wireless telecommunications network. Illustrative wireless telecommunications technologies include CDMA, GPRS, TDMA, GSM, and the like. Radio 516 might additionally or alternatively facilitate other types of wireless communications including Wi-Fi, WiMAX, LTE, or other VoIP communications. As can be appreciated, in various embodiments, radio 516 can be configured to support multiple technologies and/or multiple radios can be utilized to support multiple technologies. A wireless telecommunications network might include an array of devices, which are not shown so as to not obscure more relevant aspects of the invention. Components, such as a base station, a communications tower, or even access points (as well as other components), can provide wireless connectivity in some embodiments.

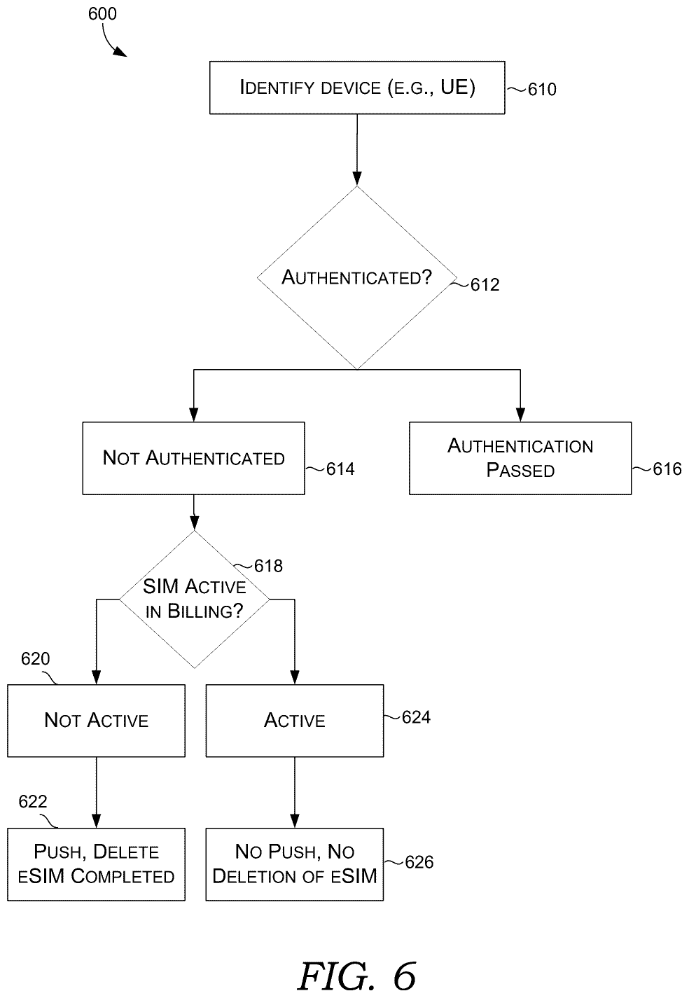

In FIG. 6, a flow diagram 600 is shown in accordance with exemplary embodiments described herein. In one example, a subscriber has called a carrier or taken some other action to render an eSIM out-of-date or “old,” for instance by discontinuing a service plan or no longer using a mobile device, such as UE 104 in FIG. 1. A system can automatically determine which mobile devices are candidates for potential removal of eSIMs due to inactivity or other indications of an old or non-used SIM. For example, at 610, a computerized system is configured to automatically identify one or more devices such as a UE, where the one or more devices are associated with eSIMs that may be out-of-date or not used.

At 612, the system determines if the SIM associated with each device (e.g., UE 104) can be or is authenticated. The system outputs an indication of not authenticated (at 614) or that an authentication passed (at 616). In the event an authentication is passed, the system can complete its analysis of the eSIM data for that device, until that device is again identified in the future as shown at 610, as a device with a potential inactive eSIM.

If the devices are not authenticated, as shown at 614, then the system determines at 618 if one or more SIMs associated with the device(s) is active or in use, for example using billing records or other logs available to network components. In some cases, a provider of network 106 in FIG. 1 remotely accesses status indicators that apply to each eSIM in order to declare a SIM as active or inactive. One or more data stores can be distributed in a backend, such as backend 222 in FIG. 2, and accessed by a system to decide if a SIM is in use or not. Various indicators relating to activity, payment, settings, locations information, etc., can be weighted or considered together to determine an active status for a SIM.

As shown, for each mobile device with a SIM found not be authenticated at 614, the system determines if the SIM is not active (at 620), in which case a push notification is provided to delete an eSIM (at 622). In response to the push notification, eSIM data is deleted from storage. Under settings, it can be confirmed on a mobile device under “Settings” that the push notification remotely, successfully erased an eSIM. Alternatively, the system determines the SIM is active (at 624). If the SIM is determined to be active, the no push notification is provided that would cause deletion of an eSIM (as shown at 626). The exemplary system depicted by the diagram in FIG. 6 includes more than one safeguard or tool to prevent the remote deletion of a SIM that should be maintained, based on authentication, as shown at 616, and based on a status (e.g., an active status), as shown at 624. Additionally, as explained above, in some cases an eSIM is active in billing or other in use, but not recognized by a core network and thus not able to be authenticated yet. In this situation, no push notification causes deletion of the eSIM because of the response the SIM is active (at 624).

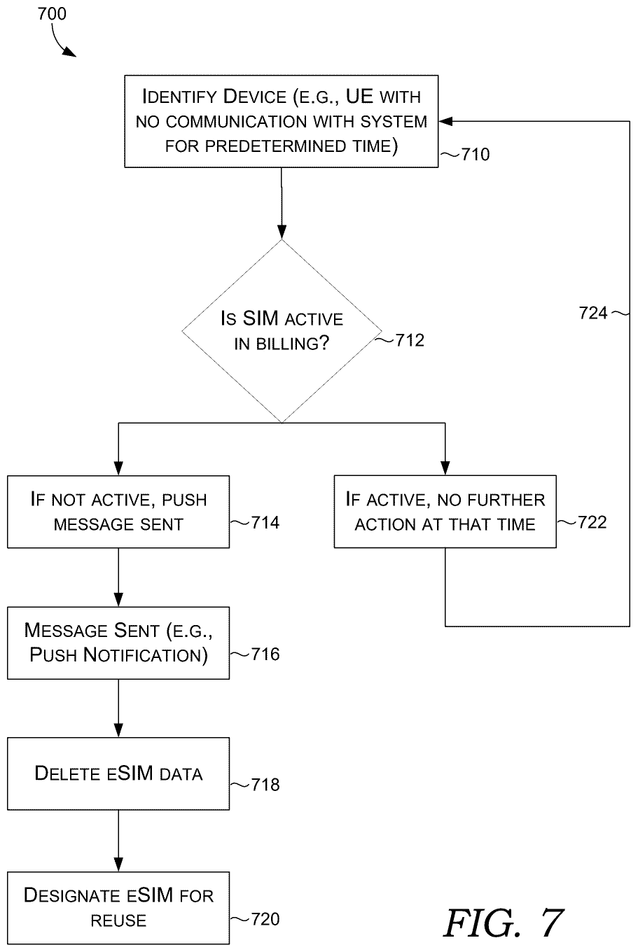

In FIG. 7, a diagram 700 is shown in accordance with embodiments of the present invention. At 710, a system identifies one or more UEs that have not communicated with a system for a predetermined amount of time. For this subset of devices, including for example UE 104 in FIG. 1, the system asks at 712 if each eSIM at issue is considered to be “in use” according to carrier information or other network-provider information, or third-party billing information that is accessed by the system. If the eSIM is not active, as shown at 714, then the system proceeds to cause a push notification to be issued, as shown at 716. This push notification causes the eSIM to be deleted, as shown at 718, and the system then designates each eSIM that has been deleted as eligible for reuse by another mobile device, as shown at 720.

If the system determines an eSIM is not still “in use” according to the accessible information about the mobile device and its associated account, as shown at 722, then no further action is taken at that time by the system, because the eSIM should not be deleted (thus no push notification is issued). Instead, the system does not take any action, but instead the mobile device can be identified again in the future if the system determines is has not communicated with a network 106 or appears unused according to some other criteria, as shown at 724.

In some cases, the system can learn over time when to initiate the actions in FIG. 7, for example using artificial intelligence, such as machine learning. The system can include a neural network that is trained to identified UEs (e.g., UE 104) that should be analyzed for eSIM deletion. The system can learn based on types of plans, types of devices (e.g., owned or leased, or age, or international capabilities), eSIM data, customer status or rights, use of network and/or UE resources, fraud risks, other flags, etc. Thus, a system can use implementations of embodiments herein to learn over time which UEs to automatically identify to potentially free up the network 106 and UE 104 from unused SIMs.

At a high level, systems and methods are provided for remotely causing deletion of an eSIM from a first mobile device, including one or more processors, and one or more computer-readable media storing computer-usable instructions that, when executed by the one or more processors, cause the one or more processors to identify the first mobile device including the first eSIM and determine the first eSIM is not authenticated, for example. Additionally, the system can automatically determine the first eSIM is not active based on a predetermined time period, for example a period of days or weeks since a last attempted contact or known location, or since a last payment or other interaction with any subscriber in relation to the eSIM. The system can cause a push notification to be sent to the first mobile device, which triggers the first mobile device to delete the first eSIM from the first mobile device, and a confirmation the first eSIM was deleted is received, in embodiments.

In some cases, the system includes receiving an indication the first eSIM is available for reuse. For instance, the first eSIM is reused by second mobile device, in some cases. In embodiments, data associating the first eSIM with the first mobile device is deleted from one or more network storage components, which provides substantial savings of resources in a network and on various network devices, along with saving resources on the mobile device. In some cases, determining the first eSIM is not active comprises determining the first mobile device has not attempted to connect to a network using the first eSIM for the predetermined time period, which can be measured or set in any time increment, and it may be dynamic based on network resources and the volume of potential eSIMs that are out-of-date, for example.

In some examples, the push notification (e.g., message 226) identifies the first eSIM to be deleted. The push notification can activate an embedded option in a component of the first mobile device to automatically self-delete the identified first eSIM, for example. A manufacturer can include this embedded option outside of particular programs or applications, so that each mobile device can receive a push notification and effectuate deletion of an eSIM without requiring user interaction or approval.

Embodiments are also directed to methods for reusing an eSIM in a network, including identifying a first mobile device including an eSIM, determining the eSIM is not authenticated, determining the eSIM is not active, and causing a notification to be delivered to the mobile device that activates a deletion of the eSIM at the first mobile device. The notification may be a push notification received by embedded messaging software at the first mobile device that does not require an application to be running. The embedded messaging software directs a first command to activate the deletion of the eSIM, for example. In some cases, the push notification includes the first command and the first command comprises executable code that is automatically initiated at the first mobile device.

In embodiments, a system receives notice the eSIM is not part of the first mobile device, based on the deletion of the eSIM, and in some cases the notice that the eSIM is not part of the first mobile device comprises a confirmation of the deletion. The system can assign the deleted eSIM to a second mobile device. In some cases, determining an eSIM is not authenticated is based on a response received from a network device, for example one or more backend carrier servers. In another embodiment, a non-transitory computer readable media has instructions stored thereon that, when executed by one or more computer processing components, cause the one or more computer processing components to perform a method for deleting an eSIM, the method comprising detecting a first eSIM has not been associated with an attempt to connect to a network for a predetermined amount of time, determining the first eSIM cannot be authenticated by the network, determining the first eSIM is not associated with an active subscription to the network, triggering a push notification that causes a deletion of the first eSIM, and receiving notice the deletion of the first eSIM is complete.

In some cases, the deletion of the first eSIM is remotely implemented based on the triggering of the push notification. The push notification may comprise a signal to a first mobile device to implement a local deletion protocol with respect to the first eSIM. The local deletion protocol causes automatic selection of an option to delete the first eSIM, in some examples. Input from one or more resources of the network indicates the first eSIM is not associated with an active subscription to the network, in embodiments. In some cases, the one or more resources of the network comprise a store of billing-related information.

Many different arrangements of the various components depicted, as well as components not shown, are possible without departing from the scope of the claims below. Embodiments of this technology have been described with the intent to be illustrative rather than be restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A system for remotely causing deletion of a first embedded Subscriber Identity Module (eSIM) from a first mobile device, the system comprising:
one or more processors; and
one or more computer-readable media storing computer-usable instructions that, when executed by the one or more processors, cause the one or more processors to:
identify the first mobile device including the first eSIM;
determine that the first eSIM is not authenticated;
determine that the first eSIM is not active based on identifying a time period during which the first eSIM has not attempted to connect to a network; and
cause a communication to be sent to the first mobile device, wherein the communication triggers the first mobile device to delete the first eSIM from the first mobile device.

2. The system of claim 1, wherein the computer-usable instructions, when executed by the one or more processors, further cause the one or more processors to receive an indication the first eSIM is available for reuse.

3. The system of claim 2, wherein the first eSIM is reused for a second mobile device.

4. The system of claim 1, wherein data associating the first eSIM with the first mobile device is deleted from one or more storage components of the network.

5. The system of claim 1, wherein the time period continues to accumulate.

6. The system of claim 1, wherein the communication comprises a push notification.

7. The system of claim 1, wherein the communication activates an embedded option in a component of the first mobile device to automatically self-delete the identified first eSIM.

8. A method for reusing an eSIM in a network, the method comprising:
identifying a first mobile device including an eSIM;
determining that the eSIM is not authenticated;
determining that the eSIM is not active;
causing a notification to be delivered to the first mobile device that activates a deletion of the eSIM at the first mobile device;
receiving a notification that the eSIM is not part of the first mobile device, wherein the notice is based on the deletion of the eSIM; and
assigning the eSIM to a second mobile device.

9. The method of claim 8, wherein the notification is a push notification received by embedded messaging software at the first mobile device that does not require an application to be running.

10. The method of claim 9, wherein the embedded messaging software directs a first command to activate the deletion of the eSIM.

11. The method of claim 10, wherein the push notification includes the first command and the first command comprises executable code that is automatically initiated at the first mobile device.

12. The method of claim 8, wherein determining the eSIM is not authenticated is based on a response received from a network device.

13. The method of claim 12, wherein the network device comprises one or more backend carrier servers.

14. The method of claim 8, wherein the notice the eSIM is not part of the first mobile device comprises a confirmation of the deletion.

15. A non-transitory computer readable media having instructions stored thereon that, when executed by one or more computer processing components, cause the one or more computer processing components to perform a method for deleting an eSIM, the method comprising:
detecting that:
a first eSIM associated with a first mobile device has not been associated with an attempt to connect to a network for a predetermined amount of time,
the first eSIM cannot be authenticated by the network, and
the first eSIM is not associated with an active subscription to the network;
triggering a communication that causes a deletion of the first eSIM; and
receiving a notification that the deletion of the first eSIM is complete.

16. The non-transitory computer readable media of claim 15, wherein the deletion of the first eSIM is remotely implemented based on the triggering of the communication.

17. The non-transitory computer readable media of claim 15, wherein the communication comprises a signal to the first mobile device to implement a local deletion protocol with respect to the first eSIM.

18. The non-transitory computer readable media of claim 17, wherein the local deletion protocol causes automatic selection of an option to delete the first eSIM.

19. The non-transitory computer readable media of claim 15, wherein input from one or more resources of the network indicates that the first eSIM is not associated with an active subscription to the network.

20. The non-transitory computer readable media of claim 19, wherein the one or more resources of the network comprise a store of billing-related information.
